(19) United States
(12) Patent Application Publication
(10) Pub. No.: US 2006/0038748 A1
(43) Pub. Date: Feb. 23, 2006

(54) Image processing method for plasma display panel

(76) Inventors: Chun-Chueh Chiu, Padeh City (TW); Chun-Hsu Lin, Padeh City (TW); Yu-Ting Chien, Padeh City (TW); Chung-Lin Fu, Padeh City (TW)

Correspondence Address: BIRCH STEWART KOLASCH & BIRCH, PO BOX 747, FALLS CHURCH, VA, 22040-0747, US

(21) Appl. No.: 10/919,306

(22) Filed: Aug. 17, 2004

(51) Int. Cl. G09G 3/28

(52) U.S. Cl. 345/60

(57) ABSTRACT

An image processing method for plasma display panels is disclosed to measure the difference of displayed brightness, color temperature and color shift as a result of the voltage drop under various operation modes. The measured data are made into a lookup table installed in the circuit board so that the circuit board can automatic calibrate the image shown on the plasma display panel.

### BACKGROUND OF THE INVENTION

1. Field of Invention

The invention relates to an image processing method and, in particular, to an image processing method for plasma display panel.

2. Description of the Related Art

The plasma display panel (PDP) is a type of display that makes use of gas discharge illumination. Its working principle is similar to that of the fluorescent lamp. A glass tube is filled with an inert gas or mercury gas. The gas is ionized by applying a voltage and then emits ultraviolet (UV) light. After the UV light hits the phosphor layer coated on the inner surface of the glass tube, the phosphor layer is excited to emit visible light whose color is determined by the type of phosphor layer.

The PDP can be regarded as many of miniaturized fluorescent lamps collected together to discharge. Each discharge space is called a cell. For a color PDP, the three types of phosphor emit red (R), green (G), and blue (B) light in three different cells, respectively. The cells coated with three different phosphor layers inside are disposed in a linear or mosaic pattern. The discharge cell discharges when a voltage is applied.

The excited UV light hits the phosphor layers coated inside the discharge cells to emit lights in RGB colors. The driver circuit design and the image signal processing can mix various kinds of colors to produce a color image.

However, since the light emission of the PDP is generated by the accumulation of multiple discharges in a sustained period. For different display images, the number of cells to discharge at the same time that a horizontal electrode crosses also varies. Therefore, different sustain electrodes have variations in discharges, resulting in a voltage drop such that the brightness, color temperature, and color shift vary even for gray-level signals. This is called the loading effect of the panel.

For example, suppose an electrode has 500 discharge cells. If a display image only needs to light up 50 discharge cells (e.g. the loading ratio is 10%), then the energy will concentrate on these 50 discharge cells, resulting in an abnormal brightness. In other words, on the same electrode, the brightness of the cells is brighter when fewer cells need to be light up. Aside from the difference in the brightness, there are also errors in the color temperature and color shift. Therefore, in order to show a correct image, one has to simultaneously solve the problems in color temperature, color shift and the brightness abnormality of the PDP.

### SUMMARY OF THE INVENTION

A primary object of the invention is to provide an image processing method for plasma display panels (PDP) to solve the problems in color temperature, color shift, and brightness caused by the loading effect. Therefore, the PDP can display calibrated images.

In view of the problems in the prior art, the invention provides an image processing method for a plasma display panel containing several electrodes and a circuit board. The method comprises the steps of: measuring the loading ratios of the electrodes under multiple operation modes; measuring the RGB and brightness gains under different loading ratios to establish a look-up table; loading the look-up table into the circuit board; letting the circuit board determine the current operation mode and the corresponding electrode loading ratios after inputting an original image; calibrating the RGB gray levels and brightness according to the look-up table for the PDP to output the calibrated image.

### BRIEF DESCRIPTION OF THE DRAWINGS

The invention will become more fully understood from the detailed description given hereinbelow illustration only, and thus are not limitative of the present invention, and wherein:

FIG. 1 is a flowchart of the cells coated with three different phosphor layers inside PDP image processing method; and

FIG. 2 is a flowchart of how to use the built-in look-up table of the circuit board to automatically calibrate an image.

### DETAILED DESCRIPTION OF THE EMBODIMENTS

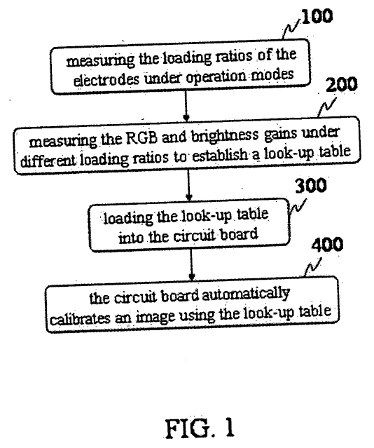

As shown in FIG. 1, the disclosed plasma display panel (PDP) image processing method mainly includes the described in detail next First, the loading ratios of multiple electrodes are measured under several operation modes (step 100). Said operation modes include different voltages and frequencies. RGB and brightness gain of various loading ratios are measured and gained in order to establish a lookup table (step 200). Said look-up table that lists the relations among the voltage, frequency, loading ratio, RGB gains, and brightness gains is loaded into a circuit board (step 300). After the input of an original image, said circuit board automatically determines the current operation mode and the electrode loading ratios. According to said look-up table, the RGB gray levels and the brightness are calibrated so that the PDP can output a calibrated image (step 400).

We further describe the detailed steps as follows. First, after selecting the voltage and frequency of the PDP and setting it as the operation mode, the loading ratio of each electrode is measured (step 100) to establish said look-up table. The loading ratio is computed using the following formula:

$$Loading ratio ( \% ) = \frac{( \begin{matrix}{\sum }_{i = 1}^{n} R gray level + {\sum }_{i = 1}^{n} G gray level + \\ {\sum }_{i = 1}^{n} B gray level\end{matrix} )}{( n * the maximum gray level value * 3 )}$$

Where n is the number of discharge cells in an electrode across. The maximum gray level value is 255 in the present embodiment, but the actual applications are not limited to this.

Afterwards, said look-up table is established according to the different loading ratios (step 200). If the color temperature is high, we take R gray level=W (white) gray level. If the color temperature is low, we use B gray level=W gray level. Suppose we choose to use B as the base color, then B is fixed at a particular level and the input gray levels of R and G are tuned. A color spectrometer is used to monitor the white color temperature and color shift after the three colors are mixed. When they are equal to the color temperature and color shift for a loading ratio of 100%, the RGB gray levels are recorded and the R and G gains are computed. The gains are the required corrections. This is done for different choices of B gray levels. Finally, one obtains a set of gray level table for correcting the color temperature and color shift and the correction gains in the R and G colors. Likewise, one can choose R as the base color. Following the same steps, one can obtain a gray level table and the correction gains for the B and G colors. It should be noted that whether color temperature is high or low, we can fix one color of R, G, and B and turn the others to obtain expected values.

When said gray level table and said RGB gains are finished recording, we further establish a list of brightness gains. For example, if the brightness at the 100% loading ratio is X and that at the 50% loading ratio is Y (at this moment, the color temperature and color shift calibrations are done), then the brightness gain is X/Y. Using the same method, we obtain the brightness gains for all RGB gray levels.

Afterwards, one selects other operation modes in order to obtain said RGB and brightness gains of each loading ratio under all operation modes. The setting of said operation mode is determined by the panel properties, which are affected by the structure, manufacturing process, and material. Here we set the voltage between 140 and 230 V. Since the frequency has some influence on the loading effect, one has to multiply an error correction for different frequencies. Therefore, tables for different frequencies have to be built, just as described above. Here we set the frequency between 6 k and 70 k Hz. Of course, the choice of frequency has to be done according to the panel properties.

In the end, the experimental data are collected to form said look-up table. In this embodiment, we group them according to the panel properties. For example, if the loading ratios of frequencies within a certain range are close to one another, we group them together. Here we group according to the frequency range: under 8 k Hz, 9˜11 k Hz, 12˜14 k Hz . . . , 58˜59 k Hz, and above 60 k Hz. The data are further separated according to the loading ratios, such as the loading ratio in the ranges of 1/o-10%, 10%˜20%, 20%-30% . . . , and 90%˜99%. One has to refine the grouping if the difference within one group is large, that is to reduce the group interval and add the group number; otherwise, no further grouping is necessary.

Said look-up table is then loaded into said circuit board of the PDP (step 300). Said circuit board automatically calibrates the image according to the data in said look-up table, solving the problems in brightness, color temperature, and color shift caused by the panel loading effect and obtaining a normal brightness and RGB ratios (step 400).

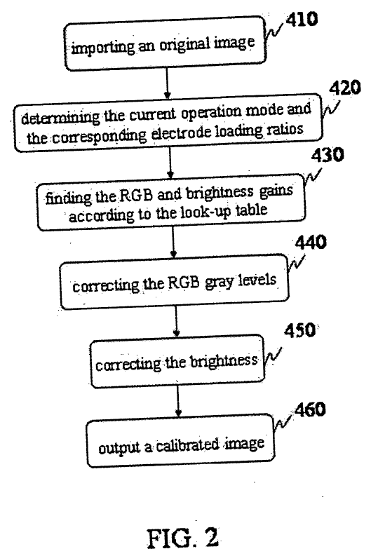

As shown in FIG. 2 to explain how the disclosed circuit automatically calibrates an image using said look-up table. When an original image is imported (step 410), said circuit board determines how much load is on each electrode and which operation mode said image is in (step 420). Said look-up table for the current voltage is selected to find the RGB and brightness gains according to the frequency and the loading ratio (step 430). The ratios of all RGB gray levels (0˜255) are restored (step 440). The brightness is corrected (step 450). Finally, the PDP can output the calibrated image (step 460).

In summary, the disclosed PDP image processing method can analyze and compute the corrections to the correct brightness, color temperature, and color shift under different loading ratios for different PDPs. The brightness and RGB gains are stored in a lookup table, which is written into a circuit board. Said circuit board is thus able to automatically compensate for the above-mentioned deviations in brightness, color temperature, and color shift for the PDP to present a calibrated image.

Certain variations would be apparent to those skilled in the art, which variations are considered within the spirit and scope of the claimed invention.

What is claimed is:

1. An image processing method for a plasma display panel (PDP) that contains a plurality of electrodes and a circuit board, the method comprising the steps of:
measuring the loading ratios of said electrodes under a plurality of operation modes;
measuring the red, green, and blue (RGB) gains and brightness gains under different loading ratios to establish a lookup table;
loading said look-up table into said circuit board; and
determining the current operation mode and the corresponding electrode loading ratios after inputting an original image to calibrate the RGB gray levels and brightness according to said look-up table of said circuit board to output the calibrated image.

2. The image processing method of claim 1, wherein said operation modes include different voltages and frequencies operated in PDP.

3. The image processing method of claim 1, wherein said step of measuring said electrode loading ratios uses the following formula:
$$Loading ratio ( \% ) = \frac{( \begin{matrix}{\sum }_{i = 1}^{n} R gray level + {\sum }_{i = 1}^{n} G gray level + \\ {\sum }_{i = 1}^{n} B gray level\end{matrix} )}{( n * the maximum gray level value * 3 )}$$
where n is the number of discharge cells crossed by each of said electrodes.

4. The image processing method of claim 3, wherein said maximum gray level value is 255.

5. The image processing method of claim 1, wherein said step of measuring said RGB gains and said brightness gains employs a color spectrometer.

6. The image processing method of claim 1, wherein said step of measuring said RGB gains and said brightness gains comprises the steps of:
computing the RGB gray level differences for correcting to the normal color temperature and color shift under different loading ratios in order to obtain a gray level table and RGB gains to correct said color temperature and color shift; and
computing the brightness difference for correcting to the normal brightness according to said gray level table in order to obtain brightness gains.

7. The image processing method of claim 6, wherein said step of computing said RGB gray level differences for correcting to said normal color temperature and color shift includes the steps of:
turning said gray levels of the other colors while fixing said gray level of one of RGB colors;
measuring the white color temperature and color shift when the RGB colors are mixed together;
recording said RGB gray levels when coinciding with said normal color temperature and color shift and computing the gains of the other colors; and
choosing other gray levels of the color for tuning said gray levels of the other colors, and repeating the above steps to obtain said gray level table and said gains of the other colors.

8. The image processing method of claim 6, wherein said step of computing said RGB gray level differences for correcting to said normal color temperature and color shift is achieved by comparing the color temperatures and color shifts at different loading ratios with those at the 100% loading ratio.

9. The image processing method of claim 6, wherein said step of computing said brightness difference for correcting to said normal brightness is achieved by comparing the brightness at different loading ratios with that at the 100% loading ratio.

10. The image processing method of claim 1, wherein said look-up table lists the relations among the voltage, frequency, loading ratio, RGB gains, and brightness gain.
